(19) United States
(12) Patent Application Publication
(10) Pub. No.: US 2018/0058216 A1
(43) Pub. Date: Mar. 1, 2018

(54) COUPLER DEVICE AND ASSEMBLY

(71) Applicants: TECHNICAL TUNNELLING COMPONENTS LIMITED, Hinckley (GB); OZENGI ASSOCIATES LIMITED, Stoke on Trent (GB)

(72) Inventors: Malcolm CHAPPELL, Kingsley Holt (GB); Anthony HARDING, Wooloowin (AU)

(73) Assignees: Technical Tunnelling Components Limited, Hinckley (GB); Ozengi Associates Limited, Stoke on Trent (GB)

(21) Appl. No.: 15/557,004

(22) PCT Filed: Feb. 26, 2016
(86) PCT No.: PCT/GB2016/050501

§ 371 Date: Sep. 8, 2017

(30) Foreign Application Priority Data
Mar. 9, 2015 (GB) 1503995.1

(51) Int. Cl. E21D 11/08; F16B 4/00; F16B 5/00

(52) U.S. Cl. CPC E21D 11/083; F16B 5/0024; F16B 4/004

(57) ABSTRACT

A coupler device is described for joining together two adjacent members 7,17 and in particular structural members which may for example may be tunnel segments, well segments, building segments, precast concrete members, preformed panels and other items used in but not limited to the construction industry. The coupler device has an elongate body 2 carrying spaced apart first and second projecting portions 6,16, wherein each of the first and second projecting portions is configured to be received within a complementarily recessed portion 8,18 in a face of a respective member and thereby in use to join together the two respective members.

The technical field of the present invention relates to a coupler device for joining two members. These members may for example be tunnel segments, well segments, building segments, precast concrete members, preformed panels and other items used in but not limited to the construction industry. The invention additionally relates to an assembly comprising at least two such members and at least one such coupler device for joining two members.

In the particular preferred case the technical field of the present invention relates to a coupler device for joining two tunnel liner segments for construction of a liner for a tunnel driven in accordance with shield tunnelling principles, and for example by a tunnel boring machine (TBM). The invention is discussed by way of example in that context in particular. However it will be understood that the invention is applicable in the generality to the joining of any two members and for example applicable to but not limited to the joining of two structural members.

The present invention in particular relates to a coupler device, including a coupler device of unitary construction and a coupler device comprising male and a female coupling members, to a male member for a coupler device, to a female member for a coupler device; to an assembly comprising two members such as structural members and in particular two tunnel segments and at least one such coupler device; and to a method of joining of two members such as structural members and in particular two tunnel segments making use of such a coupler device.

The principles of shield tunnelling are well established. A cylindrical shield at the excavation front is progressively advanced as the tunnel is driven, and a cylindrical tunnel liner is constructed in situ progressively cylindrical section by cylindrical section behind the advancing tunnelling front.

Typically a tunnel liner is assembled in situ from cylindrical segments, which are for example precast concrete, although other liner materials including cast iron and steel have also been used. Plural segments are joined together using suitable coupler devices to effect radial and longitudinal joints between adjacent segments.

The lining of the tunnel thus consists of plural precast segments which are articulated or coupled at the radial or longitudinal and the circumferential joints. It follows that the structural behaviour of the tunnel lining is affected not only by the material characteristics of the segments but also the mechanical and geometrical characteristics of the joints and couplings. Ease of assembly of the joint in situ in what is often a difficult and confined working environment, and adequate service life in the often harsh use conditions, are also important considerations in the design of coupler devices to effect the radial and circumferential joints between tunnel liner segments.

In the case of tunnel liner segments and other structural members where the joint is subject to similar environmental considerations during service, it may be necessary to effect a seal at the joint. In assembly of a tunnel liner, plural segments are joined by suitable radial/longitudinal couplings to make up a complete cylindrical section.

Typically, a suitable sealing system and for example gasket sealing system is provided in association with a radial/longitudinal joint and for example elastomeric gaskets received in grooves are provided in association with abutting radial segment edges. The joint is assembled in such manner that the gasket effects a seal, for example in that a compressive load is applied on gaskets in association with abutting segment edges to effect a closure. The coupler devices are configured to hold the joint together in such manner and for example maintain such compressive load as to be consistent with maintenance of the gasket seal. The sections are joined together successively as the tunnelling front progresses using suitable coupler devices to effect circumferential joints between successive sections. Suitable gaskets may again be provided.

In recent years, attention has been given to the development of coupling devices for joining structural members and in particular to the development of coupling devices for joining tunnel liner segments and other structural members where the joint is subject to similar constraints during fabrication and/or similar environmental considerations during service. It is generally desirable for such coupling devices to provide for ease of assembly in situ, adequate service life in the often harsh use conditions, and where applicable to co-operate effectively with joint sealing systems.

Coupler devices suitable for effecting a circumferential joint between tunnel sections include straight and curved simple bolt arrangements and, additionally or alternatively, dowel systems such as are known for example from UK patent GB 2367873 and European Patent EP 0837288.

A coupler pin for use in a radial/circumferential joint is known from JPH10-121892A. A U-shaped connector has simple pin projections 4 that are received in holes in adjacent segments and for example fixed with suitable resin-like adhesive. The simple pins do not carry a load, and are not stably located until the resin goes off. Such a system is not well suited to structures where an immediate and stable compressive load is desired such as to effect a radial joint for a gasketed lining.

The coupling of adjacent segments to effect a radial joint for a gasketed lining is typically effected by insertion of a bolt within a recessed bolt pocket and locking of the recessed bolt with the segments held in situ with a compressive load applied to close the gasket. The recessed channel is then typically filled with a suitable grouting or caulking material to complete the joint. Systems making use of straight and curved bolts, and systems making use of bolts in a transverse direction and at an angle thereto are known.

A problem with the use of such recessed bolts and other similar coupler devices to effect a radial joint is the requirement for operational action in-situ to insert and lock the bolt with the segments held in position. Such a process is difficult to automate effectively. It is likely to require direct operator access to a restricted and potentially dangerous location after the segments have been moved into position. The process may consequently impose additional engineering difficulties, costs and risk factors.

A problem with the use of such recessed bolts and other similar coupler devices to effect a radial joint is the difficulty in accessing the devices once in-situ for example for inspection, repair or replacement. Accordingly, it is generally desirable that the coupler devices used to effect the radial joint should have a long service life. Bolting systems based on metallic bolts are likely to require significant additional and associated environmental protection or modifications to give the desired service life.

Additionally, it is preferable to avoid cumbersome arrangements from a technical and/or economical point of view. Keeping manufacturing costs to a minimum is highly desirable. One may try to achieve an optimum balance between performance, especially coupling force and tensile resistance, and manufacturing costs. It is thus a problem how to improve the coupler and at the same time reducing or minimizing manufacturing costs.

It is an object of the present invention to provide a coupler device for joining two members. It is an object of the present invention to provide an assembly comprising at least two members and at least one such coupler device. It is an object of the present invention to provide a method of joining of two members making use of such a coupler device. These objects and others can be achieved by the features of the independent claims. Further enhancements are characterized in the dependent claims.

In accordance with a first aspect of the present invention, there is provided a coupler device for joining together two adjacent members and in particular structural members which may for example may be tunnel segments, well segments, building segments, precast concrete members, preformed panels and other items used in but not limited to the construction industry. In particular there is provided a coupler device for effecting a radial/longitudinal joint between two adjacent tunnel segments.

The coupler device in a broadest aspect comprises an elongate body carrying spaced apart first and second projecting portions, wherein each of the first and second projecting portions is configured to be received within a complementarily recessed portion in a face of a respective member and thereby in use to join together the two respective members.

The coupler device is distinctly characterised in the manner that it is co-operably configured with the complementarily recessed portions in the faces of the respective members it serves to join in use such that with the coupler device and its respective members assembled together the projecting portion tends to be retained in-situ in that the projecting portion and recess are co-operably structured to tend to resist removal of the projecting portion from the recess.

This is effected in that each projecting portion comprises a tapered body portion and an end portion;

each recessed portion comprises a complementarily shaped recess;

at least the end portion of the projecting portion is co-operably configured with at least an engagement portion of the complementarily shaped recess such as to tend to resist removal of the projecting portion from the recess when the projecting portion is located therein.

The precise configuration of projection and recess may be purpose designed and engineered as required to suit a desired purpose, and in particular engineered as required to suit operational loading conditions. It is so designed and engineered that the projection couples readily within the recess during construction, but the structure is such that when so coupled the structure acts to resist decoupling by resisting removal of the projection from the recess.

In accordance with a second aspect of the invention, there is provided an assembly comprising at least two members such as structural members and at least one coupler device in accordance with the first aspect of the invention for joining together two adjacent members. In particular there is provided an assembly comprising at least two tunnel segments and a coupler device for effecting a radial/longitudinal joint between two adjacent tunnel segments.

The assembly in a broadest aspect comprises at least one coupler device for joining together two adjacent members, wherein the coupler device has an elongate body carrying spaced apart first and second projecting portions, provided in association with at least two members to be joined by the coupler device each provided with a recessed portion in a face thereof; wherein each of the first and second projecting portions is co-operably configured with a complementarily recessed portion in a face of a respective member such that the projecting portion is adapted to be received within the complementarily recessed portion in the face of a respective member;

characterised in that:

each projecting portion comprises a tapered body portion and an end portion;

each recessed portion comprises a complementarily shaped recess;

at least the end portion of the projecting portion is co-operably configured with at least an engagement portion of the complementarily shaped recess such as to tend to resist removal of the projecting portion from the recess when the projecting portion is located therein.

With both such projecting portions received within a complementarily recessed portion in the face of a respective member the coupler device thereby acts in use to join together the two respective members.

The invention in both aspects is characterised in that when the coupler device and its respective members assembled together the tapered body portion of the projecting portion locates within a complementarily tapered portion of the recess. Thus the projecting portion is located correctly in the recess. Additionally the projecting portion tends to be retained in-situ in the corresponding recess, in that at least the end portion of the projecting portion engages with at least an engagement portion of the complementarily shaped recess such as to effect a retaining fit such as to tend to resist disengagement. Thus, the projecting portion is inherently and immediately held in the recess in such manner as to resist removal and thus inherently and immediately carry a load. The end portion of the projecting portion and the engagement portion of the complementarily shaped recess may be similarly or differently tapered or cylindrical or otherwise structured to effect this retaining fit.

In a possible embodiment the tapered body portion and the complementarily tapered portion of the recess are co-operably shaped to effect a close fit but with some tolerance to act as a guide means. The end portion of the projecting portion and the engagement portion of the complementarily shaped recess are co-operably configured to effect a retaining fit such as to tend to resist disengagement. In an alternative embodiment an entire projecting portion. In an alternative embodiment the entire portion and recess may be co-operably configured to effect a retaining fit such as to tend to resist disengagement.

The retaining fit is for example an interference fit, which term herein encompasses a simple interference fit between snugly engaged components, a structured interference fit in which at least one of the components has a surface modified structurally to enhance the fit between snugly engaged components, and a structured interlock fit in which the components have mutually modified surfaces comprising complementary engageable structural elements to enhance the retaining fit.

As a result a number of advantages potentially accrue, particularly when the invention is in the preferred case applied to the provision of an assembly comprising at least two tunnel segments and a coupler device for effecting a radial/longitudinal joint between two adjacent tunnel segments.

The taper may facilitate alignment on assembly and ensure that a correct retaining engagement that immediately resists removal is established.

The inherent and immediate retaining fit established when the projecting portion locates in-situ in the corresponding recess means that the coupler device can resist a tensile load immediately and immediately act as a retaining member for a radial/longitudinal joint between two adjacent tunnel segments. There is no requirement to wait for a resinous material to go off or for a bolt to be fastened for instance.

In particular in the preferred case where a compressed gasketed seal is provided, the coupler device can maintain a tensile resistance to maintain the integrity of the seal.

A compressive force would be applied to the gasket seal in situ during assembly by the segment erector and the coupler. The coupler is designed to resist the tensile force exerted as the compressed gaskets try to uncompress and resist the force of the gaskets as they try to push the adjacent segments apart.

The coupler device, particularly when in co-operation with such a seal, is thus able to resist some of the internal operational pressures which might typically arise within a tunnel.

The coupler device may be prefitted to a tunnel segment to facilitate assembly.

The complexity of the fitting process in situ and the need for operator intervention may be reduced. In the preferred case the assembly method lends itself to automation within the tunnel. Reduction or elimination of operator presence in the tunnel during assembly may have both safety and cost advantages during fabrication.

Further operational and safety advantages may accrue during operational life, for example when the connector of the invention is compared with a simple bolt. The connector may be made durable for the design life of the tunnel so that it does not fall out once the tunnel has gone into service, a known problem with simple bolts. This is particularly true in the preferred embodiment where the connector is fabricated with a plastic overmould offering greatly increased design life.

Externally exposed metal parts such as bolts are not required, and the coupler device may thus be modified to resist the harsh tunnel environment, for example in that exposed surfaces are of resistant plastics materials.

In accordance with the principles of the invention, a coupler device is provided with an elongate body, with a first projecting portion for example at or towards the first end and a second projecting portion spaced apart from it for example at or towards second end, with each projecting portion shaped and confirmed to be received within a corresponding recess in a receiving face of one or other of the two members to be joined. The first projecting portion is received within a recess in a receiving face of a first such member. The second projecting portion is received within a recess in a receiving face of the second such member. The arrangement is configured, and in particular the body portion is of a suitable length relative to the positioning of the respective recesses that, the first and second members are thereby joined together in adjacent manner and for example with respective adjacent ends thereof abutting.

A first member is provided with a first recess shaped to receive a first projecting portion of a coupler device in accordance with the first aspect of the invention, and a second member is provided with a second recess shaped to receive a second projecting portion of a coupler device in accordance with the first aspect of the invention. The respective first and second recesses are for example provided in respective corresponding faces of the members towards adjacent edges thereof. An elongate body portion spaces the first and second projecting portions apart to a suitable distance.

The invention in accordance with the first two aspects is in particular suited to the problem of effecting of a radial/longitudinal joint in situ between two adjacent tunnel segments of a tunnel liner for example being tunnel liner segments for a tunnel driven in accordance with shield tunnelling principles, and for example a TBM.

In application of the invention in its broadest concept to such a problem, a first tunnel liner segment is provided with a first recess shaped to receive a first projecting portion of a coupler device in accordance with the first aspect of the invention, and a second tunnel segment is provided with a second recess shaped to receive a second projecting portion of a coupler device in accordance with the first aspect of the invention. The respective first and second recesses are for example provided in respective end faces of the tunnel segments towards adjacent edges thereof. An elongate body portion spaces the first and second projection portions apart to a suitable distance to ensure that when so located the coupler device acts to hold the radial/longitudinal joint between the adjacent segments together, and in particular in the preferred case where a gasketed seal is provided, to maintain pressure to maintain the seal.

Although the invention is not seen as limited to the provision of a coupler device for a radial/longitudinal joint between two adjacent tunnel segments, a number of particular advances accrue in the context of the first and second aspects of the invention when so applied and when compared with prior art inserted bolts.

A method requiring in-situ bolting into recessed portions of the internal face of a tunnelled section with the segments in-situ require an operator in the tunnel area and cannot readily be mechanised. This is particularly the case when the bolt needs to be fixed whilst a compressive load is being maintained to keep a gasket seal closed. Also, bolts are typically metal items, with corrosion/material protection issues. The bolt is applied on an internal face of the segments. The method requires a pocket or recess on the internal face of the tunnel section which has to be filled, again in a secondary operation, once the segments are in-situ.

By contrast, a system based on the principles of the invention lends itself much more readily to automation. Location of a coupler device in accordance with the first aspect of the invention into an adjacent pair of tunnel segments may be achieved by a simple push fit. In typical tunnel lining operations, segments are already held in place by suitable machinery with an applied jointing force, and in particular in the preferred case an applied gasket pressure, in order to allow for the joint, and in particular for the gasketed joint, be locked into position by insertion and locking of the bolts. It would be a simple process to dispense with the bolting operation altogether and instead to modify such machinery to effect direct insertion of coupler devices in accordance with the principles of the first aspect of the invention, for example of both projecting portions into respective recesses in situ or by pre-location of a first and insertion of the second to complete the joint in situ.. Devices in accordance with the principles of the first aspect of the invention can be incorporated successively around a ring of segments as the segments are successively positioned in place.

As is discussed in more detail below, embodiments of the coupler device of the first aspect of the invention are more readily fabricated from plastics material, for example from plastics material alone or from metal reinforcement/body structures that are entirely overmoulded with plastics material, potentially improving in-situ life.

A coupler device of the invention may be fitted to an end face of each of a pair of adjacent segments. There is no need for pockets to be provided on an internal face of a tunnel section, and consequently no potential leak path or secondary filling requirement, as in the preferred case the coupler devices are configured to engage within apertures in the end faces of the tunnel segments.

In accordance with the invention a coupler device comprises a pair of projecting portions respectively configured to be received in a corresponding recessed portion of each of a pair of members to be joined. A recessed portion may be formed directly in a face of a member itself complementarily structured to receive the projecting portion for example comprising merely an apertured portion of its structure. A projecting portion may be a monolithic construction to be received therein directly.

Alternatively in a possible embodiment a projecting portion is provided in association with a receiving formation structured to be retained within a member and thereby when so retained form a complementary recessed portion therein complementarily structured to receive the projecting portion and for example to effect a mating connection with the projecting portion. A receiving formation in accordance with this embodiment may comprise a modular construction.

Thus in such an embodiment a coupler device assembly comprises a coupler device as herein described having an elongate body carrying spaced apart first and second projecting portions, at least one of which projecting portions is provided in combination with a receiving formation structured to be retained within a member and thereby when so retained form a complementary recessed portion therein complementarily structured to receive the projecting portion and for example to effect a mating connection with the projecting portion. In this manner, the receiving formation when retained within a member defines a recessed portion in a face of the said member adapted to receive the corresponding projecting portion in the manner herein described.

In such an embodiment, the projecting formation serves as a male portion or pin of a two-part coupling and the receiving formation serves as a female portion or socket of a two-part coupling, and the invention comprises a coupler device assembly comprising a coupler device as herein described having at least one projection configured as such a male portion or pin and a corresponding receiving formation configured as such a female portion or socket.

In such an embodiment, the receiving formation may be fixedly retained into, or constructed integrally with, a member prior to its connection to adjacent members. The receiving formation may be cast directly into a pre-cast member prior to connection of adjacent members. The receiving formation may in this case comprise a suitably configured lining for a rebate formed within a member. Alternatively the receiving formation may be configured for insertion into such a rebate prior to or as part of the connection process.

In such an embodiment, the other projecting portion may be similarly a two-part coupling in which the other projecting portion is also provided in combination with a receiving formation structured to be retained within a member and thereby when so retained form a complementary recessed portion therein complementarily structured to receive the projecting portion. Alternatively the other projecting portion may be configured as a one-part formation to effect a direct coupling into a recessed portion formed directly in a face of a member for example comprising merely an apertured portion of its structure.

It will be understood that references herein to a projecting portion and to a recessed portion and to any example coupling and retention mechanisms acting between them apply to all such arrangements whether the projecting portion engages a recess directly formed in a member or whether a projecting portion engages a recessed portion in a receiving formation in a two or more part coupler device assembly.

In one embodiment, a coupler device in accordance with the first aspect of the invention and for use in an assembly in accordance with the second aspect of the invention may simply comprise an elongate body with a first projecting portion perpendicular to the body at or towards a first end and a second projecting portion perpendicular to the body at or towards the second end. The invention also encompasses other configurations of first and second projecting portions.

The first and second projecting portions, adapted to be respectively received within recesses in the respective first and second members, may be identical or different. In a possible convenient embodiment, which lends itself particularly to the use of the principles of the invention to connect a plural serial array of members successively, and for example to connect a plural array of cylindrical segments successively to complete a cylindrical section for example in a tunnel lining, different first and second projecting portions are provided.

Thus, in an embodiment of the invention comprising a plurality of coupler devices configured to join a plurality of members, each coupler device has a first projecting portion comprising a projecting formation of a first configuration and a second projecting portion comprising a projecting formation of a second configuration. Each member to be joined has a first recess conformed complementarily to the first projecting formation on a face towards a first end, and a second recess conformed complementarily to the second projecting formation on a face towards a second end remote from the first end. Thus, a single coupler device with dissimilar projecting portions is received respectively in dissimilar recesses at adjacent first and second ends of adjacent first and second members, and plural such members may then successively be joined in a serial array, and for example plural tunnel segments may successively be joined around a cylindrical tunnel section.

A projecting portion and a complementary recessed portion are preferably mutually configured such that with the coupler device and its respective members assembled together the projecting portion is retained in-situ. That is, the projecting portion and recess are co-operably structured in such manner as to tend to resist removal of the projecting portion from the recess.

In a possible embodiment, a projecting portion and corresponding recess are co-operably adapted to engage together in an interference fit. A projecting portion and recess may be so adapted for example in that they are complementarily shaped to effect a progressively tighter fit as the projecting portion is inserted into the recess and/or in that one, other or both of the projecting portion and the recess has a profiled engaging surface and/or in that one, other or both of the projection and the recess is fabricated from, or has surface portion fabricated from, flexibly resilient material.

A suitable projecting portion is for example tapered. A suitable projecting portion may have an elliptical or circular cross section. A suitable projecting portion is frustoconical.

Additionally or alternatively a projecting portion and complementary recess may be complementarily configured to provide for a retention mechanism and for example a locking mechanism as the projecting portion is inserted into the recess, which mechanism acts mechanically to resist removal of the inserted projecting portion.

A suitable mechanism might for example include co-operable arrangements of protuberances and cavities and for example locking detents and locking recesses which tend to permit the insertion of the projecting portion into the recessed portion in a first direction, but tend to resist its extraction in a second direction.

In one embodiment a projecting portion comprises an elongate formation and for example a tapered or cylindrical elongate formation the surface of which is formed into series of grooves and protuberances and there is provided a receiving portion incorporating a complementarily tapered section defining a recess having complementary grooves and protuberances which tend to retain the projecting portion as it is inserted.

Either or both of the sets of grooves and protuberances may be fabricated of elastically resilient material.

The recessed portion of the member is for example configured as such a receiving portion or the receiving portion is for example configured as a separate component to be fixedly received therein.

In one embodiment a projecting portion comprises an elongate formation and for example a tapered or cylindrical elongate formation the surface of which is formed into series of grooves and there is provided a receiving portion in association with a member comprising a first part incorporating a reverse tapered section defining a recess in the member and a second part having an expandable collar formed of a number of arcuate segments, said arcuate segments having complementary grooves formed on their inner surface to mate with the grooved elongate formation of said first part and a tapered external circumferential portion to abut the reverse tapered section of said second part, said arcuate segments being retained elastically within the second part as the projecting portion is inserted. The arcuate segments may be retained by a membrane of elastically resilient material.

In use as the coupling device projecting portion is are urged into the recess the cylindrical grooved portion of the projecting portion abuts the internally grooved arcuate segments retained in the reverse tapered section of the recess formed in the member, forcing back and radially outwards the expandable collar formed by the arcuate segments. The movement of the expandable collar is resisted elastically which forces the mating grooves around the internal surfaces of the ring of arcuate segments to engage the cylindrical grooved portion of the projecting portion. The tapered external surfaces of the ring of arcuate segments engage the surrounding reverse tapered section of the recess thus locking the projecting portion into the recess formed in the member preventing the device from pulling out.

Thus in this embodiment the locking mechanism parallels that of UK Patent No 2367873 preferred features of which are incorporated herein by reference.

In a possible embodiment, a projecting portion may be fixedly retained into, or constructed integrally with, a member prior to connection of adjacent members. For example, in particular in a case where plural such members are to be joined successively, a first projecting portion may be fixed into, and for example formed integrally with, a first end of a member, and second end of a member may be provided with a connectable arrangement of complimentary projection and recess, for example including a locking mechanism and/or interference fit mechanism as above described. Thus, plural members may be successively joined in serial array, and for example plural tunnel segments may be successively joined into a cylindrical tunnel section.

In a possible embodiment, a projecting portion may be cast directly into a pre-cast member prior to assembly of that member with an adjacent member in the manner above described.

The coupler device in accordance with the first aspect of the invention and for use in an assembly in accordance with the second aspect of the invention may be of simple monolithic construction, for example as a one piece moulding or as a monolithic overmoulding on a suitable structural core.

In a possible embodiment the coupler device is fabricated from and/or has an external surface and/or protective covering fabricated from a material resistant to environmental degradation in use The coupler device is preferably fabricated from and/or has an external surface and/or protective covering fabricated from a non-ferrous material, and for example a non-metallic material and for example a plastics material. However in the alternative suitable metallic materials could be considered.

Suitable materials for fabrication of the coupler device in accordance with the first aspect of the invention for example as a monolithic construction and/or as an external layer and/or of a coating thereof applied at least on an outer contact surface of the projecting portion might include without limitation: acrylonitrile butadiene styrene, polyamides, polycarbonates, polyaryletherketones, polyimides, polysulfones, polyphenol sulfides, polyphenol oxides, polytetrafluoroethylene, polyacetals and similar high performance engineering thermoplastics. In a particular embodiment, the material of the coupler device comprises polyoxymethylene (acetal).

In the case of embodiments of the invention comprising a separate receiving formation structured to be retained within a member for example to effect a mating connection with the projecting portion, similar materials may be preferred.

In one embodiment the coupler device comprises an overmoulding on a suitable structural core. A structural core may comprise an elongate rod or bar. A structural core may comprise a metallic or non-metallic core and is for example a steel rod or bar. An overmoulding may comprise a suitable engineering thermoplastic for example as listed above.

A member to be joined in accordance with the principles of the invention for example comprises a structural member, which may for example be a tunnel segment, a well segment, a building segment, a precast concrete member, a preformed panel or other like member used in but not limited to the construction industry.

A member to be joined in accordance with the principles of the invention may be pre-fabricated for assembly in situ and for example comprises a structural module pre-fabricated for assembly into a structural whole in situ.

In a particular preferred case a member may be tunnel liner segment such as is used in fabrication of a liner for a tunnel driven in accordance with shield tunnelling principles, and for example by a tunnel boring machine (TBM).

A member to be joined in accordance with the principles of the invention may be fabricated for example from cast iron, steel, or concrete which may optionally reinforced. A member in a particular preferred case comprises an optionally reinforced concrete pre-cast.

In accordance with a third aspect of the present invention, there is provided a method for joining adjacently together two members and in particular structural members which may for example may be tunnel segments, well segments, building segments, precast concrete members, preformed panels and other items used in but not limited to the construction industry. In particular there is provided a method for effecting a radial/longitudinal joint between two adjacent tunnel segments.

The method in its broadest concept comprises the steps of:

providing each of two members to be joined with a recessed portion in a face thereof, for example in a region of the face thereof in the vicinity of an edge to be joined;

providing a coupler device having an elongate body and spaced apart first and second projecting portions, wherein each of the first and second projecting portions is configured to be receivingly engaged within a respective recessed portion in the face of the respective member in that each projecting portion comprises a tapered body portion and an end portion each of two members to be joined has a recessed portion in a face thereof comprising a complementarily shaped recess, and at least the end portion of the projecting portion is co-operably configured with at least an engagement portion of the complementarily shaped recess such as to tend to resist removal of the projecting portion from the recess when the projecting portion is located therein;

causing each projecting portion to be received within, and to become engaged within, its respective recessed portion and thereby joining together the two respective members.

The method is in particular a method of use of a coupler device in accordance with the first aspect of the invention to assemble and an assembly in accordance with the second aspect of the invention, and preferred features described herein above in the contents of those aspects will be understood to apply by analogy.

In particular, the method comprises:

bringing together a first and a second member adjacently such that an edge of a first member and an edge of a second member are held in face to face abutment;

providing a recessed portion in a face of each member in the vicinity of the respective edges;

causing each projecting portion of a coupler device as above described to be received within, and in the preferred case to become engaged within, a respective recessed portion and thereby joining together the two respective members.

In a possible embodiment adjacent members in face to face abutment may be urged together to create a compressive force between them prior to joining. The method comprises the step of applying a force to urge the first and second members together prior to joining.

In a preferred embodiment of the method, adjacent members may be brought together in a sealing manner. For example, a gasket seal may be provided between edges of adjacent members in face to face abutment, and the members may be urged together to create a compressive force to close the gasket prior to joining.

In a preferred embodiment of the method, the method is applied as a method of joining first and second tunnel segments, and comprises the steps of:

bringing together a first and a second tunnel segment so that the longitudinal edges are in face to face abutment;

providing a recessed portion in a face of each tunnel segment in the vicinity of the respective longitudinal edges;

optionally applying a force to urge the first and second segments together, for example to close a seal;

causing each projecting portion of a coupler device as above described to be received within, and in the preferred case to become engaged within, a respective recessed portion and thereby joining together the two respective tunnel segments.

A coupler device in accordance with the first aspect of the invention provides a simple connector to connect and hold together in adjacent jointed manner, and in particular where a joint preload for example to load a gasket has been applied, two adjacent structural members with suitably configured recesses, which may in a particular preferred case be two adjacent tunnel segments, in the manner described. An assembly in accordance with the second aspect comprises at least two such members with suitably configured recesses and at least one such coupler device being co-operably configured to connect and hold together a pair of members in adjacent jointed manner. A method in accordance with the third aspect is a method of use of a coupler device in accordance with the first aspect to assemble members in an assembly in accordance with the second aspect. Regardless of whether they are discussed in the context of one or other such aspect, the skilled person will understand that preferred features of one aspect will apply to other aspects by analogy.

The accompanying drawings, which are incorporated in and constitute a part of the specification, illustrate presently preferred exemplary embodiments of the invention, and together with the general description given above and the detailed description of the preferred embodiments given below, serve to explain, by way of example, the principles of the invention.

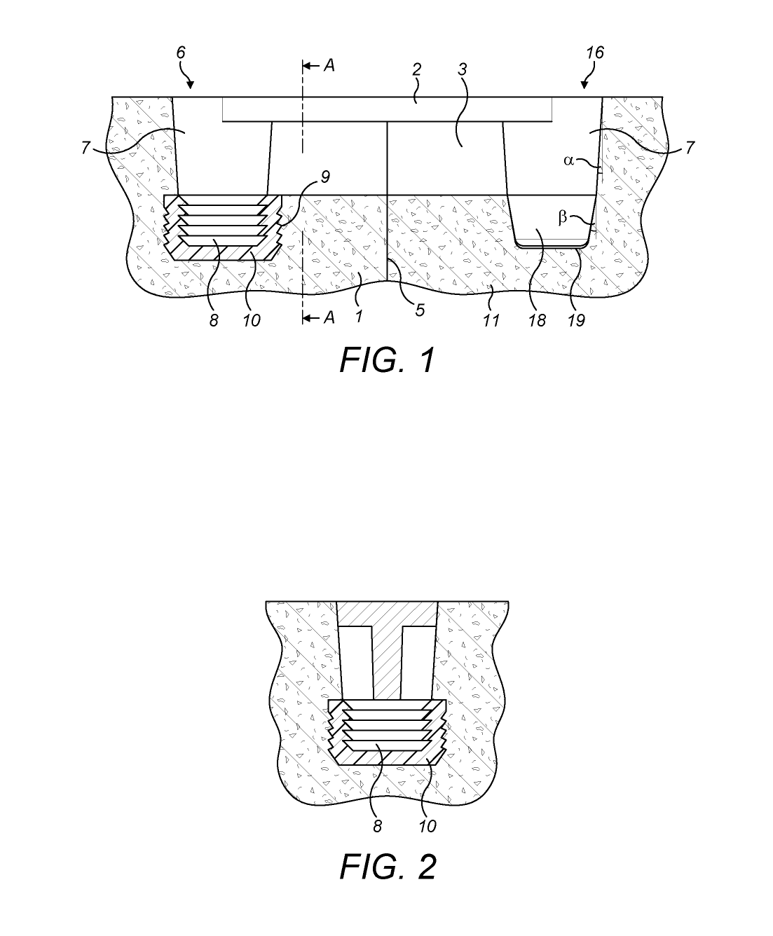

FIG. 1 shows in partial cross-section an exemplary embodiment of a coupler device in accordance with an embodiment of the invention received in and connecting two pre-cast concrete members.

FIG. 2 shows in cross-section a projecting portion of the coupler device of FIG. 1 in situ.

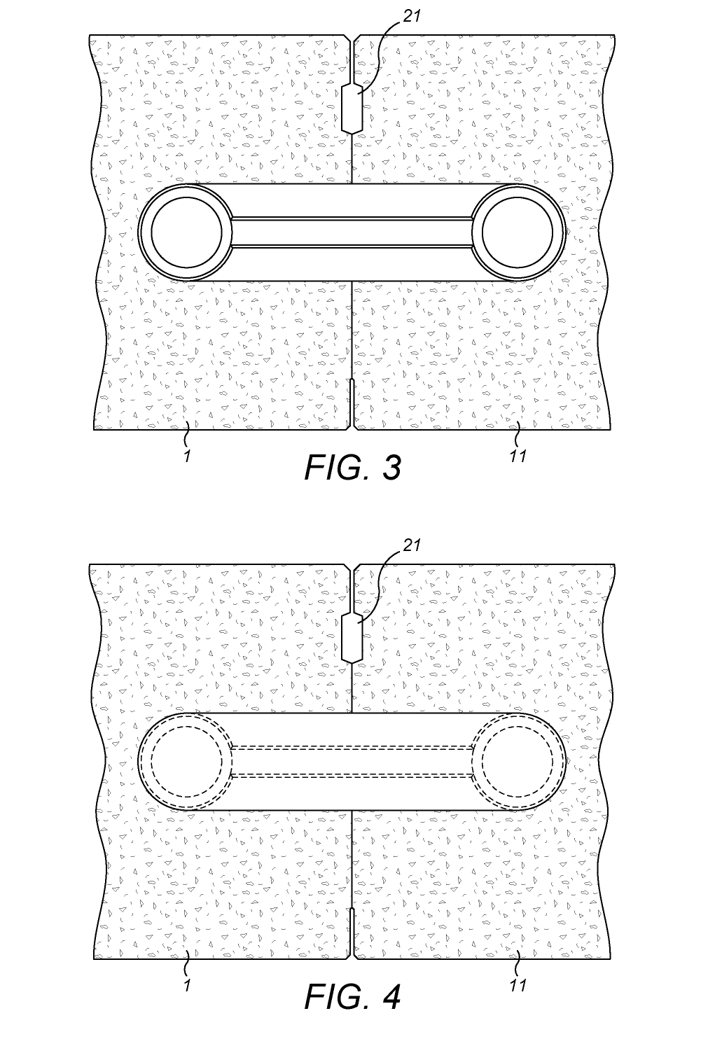

FIG. 3 shows an end elevation of the joint of FIG. 1.

FIG. 4 shows an end elevation from the other side of the joint of FIG. 1.

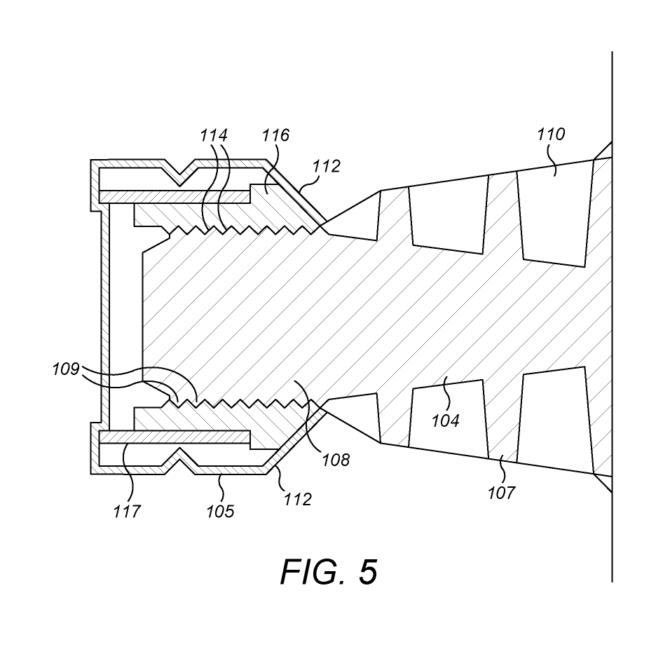

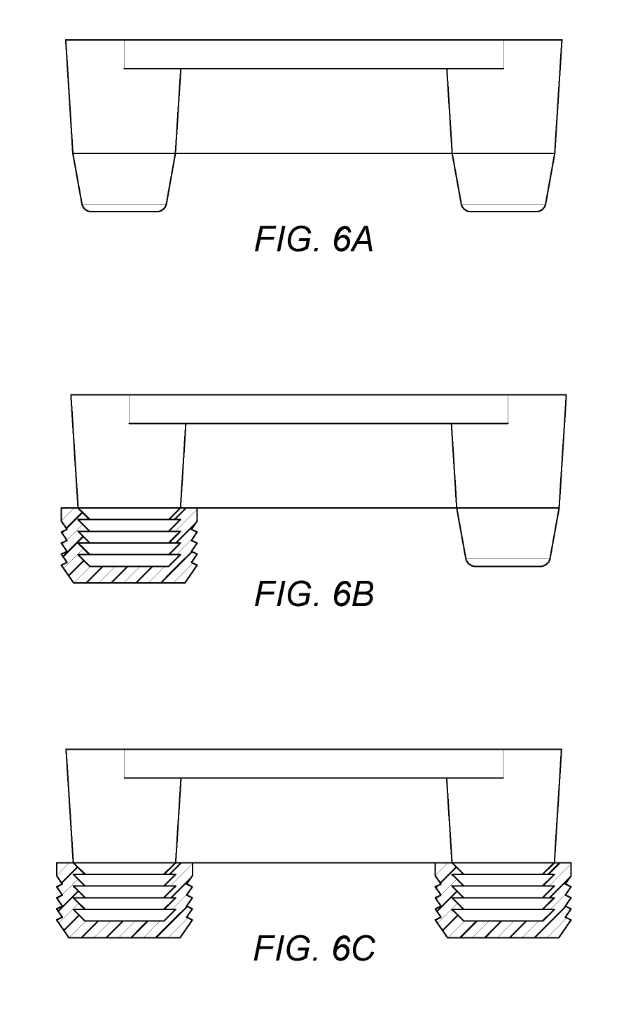

FIG. 5 shows an alternative exemplary embodiment of a projecting portion coupling male member (pin) and female member (socket).

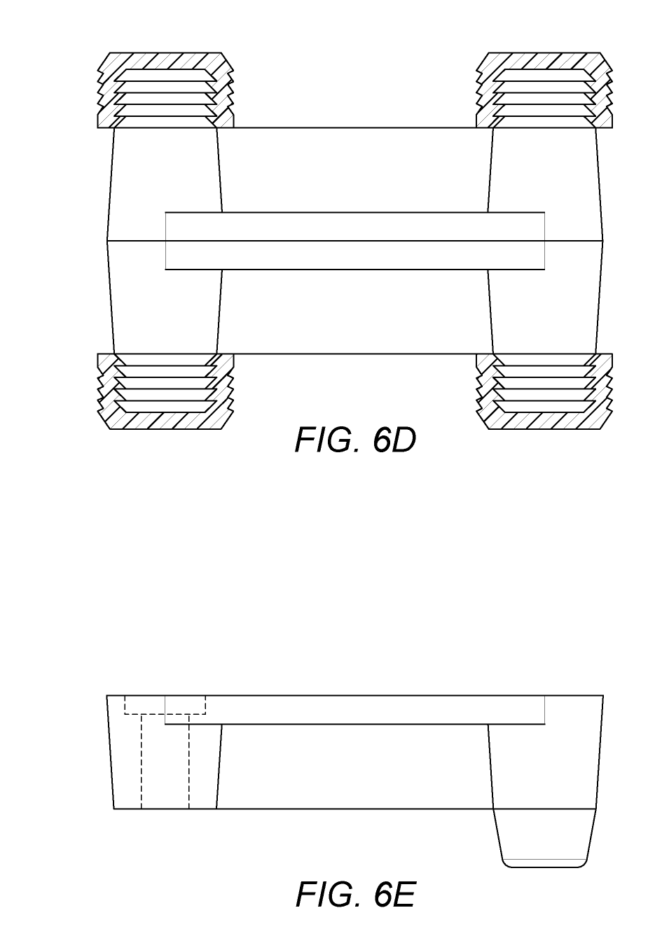

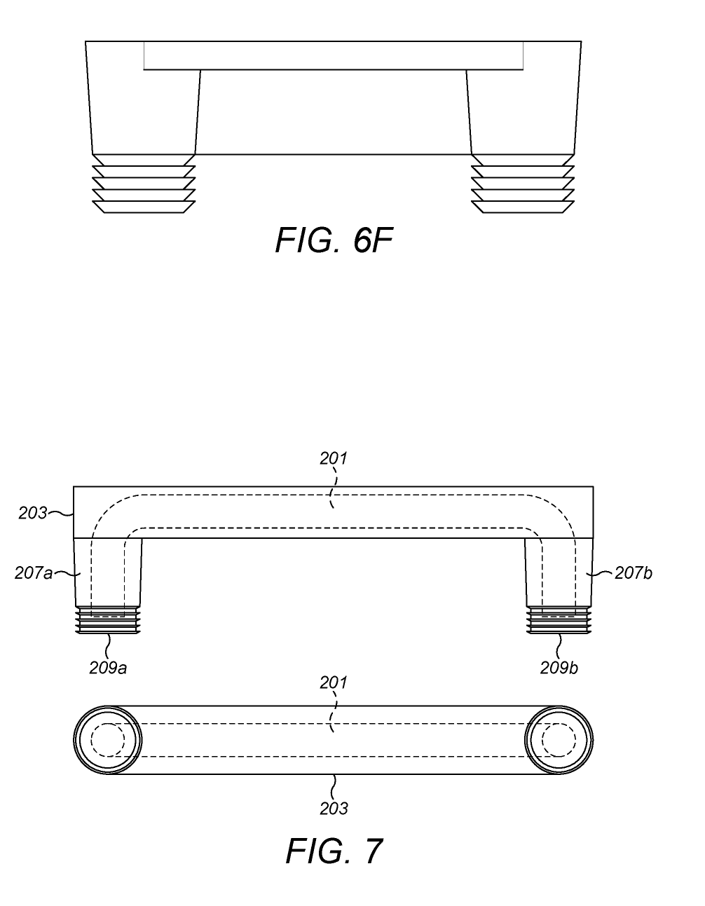

FIG. 6 shows alternative forms of coupler device embodying the general principles of FIG. 1;

FIG. 7 illustrates a possible internal structure and method of fabrication of a coupler device embodying the general principles of FIG. 1.

In accordance with the illustrated embodiment, a coupler device effects a joint in accordance with the principles of the invention at the longitudinal joint between two adjacent tunnel segments. As the skilled person will appreciate, the same general principles could be applied in similar manner to a joint between other pairs of structural members including without limitation tunnel segments, well segments, building segments, precast concrete members, preformed panels and other items used in but not limited to the construction industry. In the example embodiments a coupler device is shown with a flat profile, which is likely to be appropriate for application in larger diameter tunnels where the effective curvature of the tunnel is small on the scale of the connector, but for smaller diameter tunnels the skilled person will appreciate that a curved product that accommodates the curve of the smaller diameter of the tunnel or more particularly matches the pitch circle diameter of the fixing holes in the segments might be preferred.

FIGS. 1 to 4 illustrate a first possible embodiment, in which a coupler device in accordance with a first exemplification of the first aspect of the invention is shown effecting a longitudinal joint between two adjacent tunnel segments in accordance with an exemplification of the third aspect of the invention, thereby constituting an assembly in accordance with the second aspect of the invention.

FIG. 1 shows in partial cross-section an exemplary embodiment of a coupler device in a received position within a receiving channel defined by a pair of adjacent members, which in the example embodiment might for example be pre-cast concrete tunnel segments.

The coupler device comprises an elongate central bar 2 having dissimilarly configured projecting portions 6, 16 respectively disposed at either end. The coupler device in the example embodiment is an acetal overmoulding on a steel reinforcing rod. The material of the overmoulding gives good environmental resistance in-situ, and the reinforcing rod provides additional stiffness. Other materials could be considered for the reinforcing rod and/or the reinforcing rod could be dispensed with in a single monolithic moulding. Other engineering thermoplastic or other plastics materials may be used for the overmoulding or monolith.

The coupler device is shown in-situ effecting a joint between two adjacent members 1, 11 which in the embodiment may be pre-cast concrete tunnel segments arranged so that adjacent edge faces abut to form a longitudinal or radial joint. The tunnel segments may for example be rectangular or trapezoidal segments or have any other standard shape.

As so assembled, the respective members 1, 11 define a channel 3 into which the coupler device is generally received when the two members are in edge to edge abutment at the joint 5, in the example being the longitudinal joint between the two adjacent tunnel segments.

In the illustrated embodiment 2 different coupling mechanisms are shown by way of example between the respective projecting portion 6, 16. As will be understood, the principles of the invention admit that the respective projecting portions and recesses may be co-operably configured to effect similar of dissimilar connections.

In the exemplary embodiment, the projecting portions 6, 16 each include a respective body portion 7, 17 and respective engaging portions 8, 18. The projecting portions 7, 17 are given a frustoconical taper with a taper angle α which in the embodiment is about 3°. In the exemplary embodiments these are identically conformed. It is in respect of the engagement portions that the two projections differ from one another.

In the exemplary embodiment, the first projection is provided with a two-piece coupling arrangement. An engagement portion 8 comprises a profiled projecting male portion or pin to be engagingly received within a female portion or socket comprising a profiled plastic socket 9. The pin and socket are profiled to facilitate a push fit engagement by the provision of complementary annular profiled grooves on the pin 8 and within the internal wall of the socket 10. The grooves are such as to give the surface of the pin a wedge-shaped profile so configured as to tend to allow insertion of the pin into the socket but to tend to resist its removal. A similar arrangement of grooves is provided on an external surface of the profile plastic socket 9 to retain it within an apertured portion in the first member 1.

To assemble this first coupling, the profile plastic socket is typically first incorporated into the member 1. It may for example be pre-fitted into a suitably shaped aperture or, more simply, precast into the member. The first projection 6 can then simply be press fitted into this socket when the joint is assembled, the profiled edges of the grooves of the engaging portion 8 of the pin engaging within the socket.

In the illustrated embodiment, the second projection 16 is provided with a different engagement system. An engagement portion 18 comprises a more tapered frustoconical portion with a taper angle β which in the embodiment is around 10°. This tapered portion 18 may be adapted to effect an interference fit at a surface 19 of a correspondingly apertured portion of the member 11, or may for example be cast directly into the member 11.

In accordance with an example mode of assembly of successive pairs of members in a successive array, and for example of successive tunnel segments to complete a tunnel section, each member may be provided with a coupler device which is pre-fixed into and for example pre-cast into an end to be joined, with an adjacent end to be joined of an adjacent member being adapted to receive the other projection when the joint is assembled. In this way, successive members may be successively joined in an array, and successive segments may be successively jointed around a tunnel section. For example in the case of the illustrated embodiment, each member is provided at first end with a coupler device cast into the structure for example in the manner illustrated by the second projection 16 in the second member 11, and with a pre-cast socket at a second end ready to receive a corresponding pin projection for example in the manner illustrated by the first projection 6 and socket 10 in the first member 1. In this way, successive members and for example successive segments may be progressively assembled.

The first projection 6 is further illustrated in cross-section in FIG. 2 and respective end views of the joint from either side, from view B in the case of FIG. 3 and from view C in the case of FIG. 4, are illustrated.

As FIGS. 3 and 4 illustrate, the coupling device of the invention is readily compatible with the provision of a sealing joint. A groove 21 is shown at the joint for receiving a sealing gasket (not shown). In practice as the joint is assembled the respective members 1, 11 may be held together to apply compressive force to the seal and the coupler device configured to tend to retain that compressive force and so to tend to retain the seal in sealed configuration.

A further exemplification of an alternative projecting portion and coupling is illustrated in FIG. 5. In particular, FIG. 5 represents an alternative arrangement of multi-piece coupling embodying the principles of a pin and socket as a mating male and female member.

In the exemplary embodiment of FIG. 5 a projecting portion is shown having a central double conical core 107 which acts as a dowel and a cylindrical end portion 108 adjacent to the central double conical part of the core 107 which acts as an engagement formation. The external surface of the cylindrical end portion 108 has grooves 109 around its circumference.

The central double conical part of the core 107 assists in the alignment between units and incorporates recesses 110 to provide a limited amount of flexibility without reducing the sheer and tensile capacity of the projecting portion. Longitudinally along the centre of the projection 104 there may be a totally encased strengthening rod of another material.

Encased at the end of the recess in the member there is an external sleeve 105 which has a reverse tapered portion 112 encasing expandable collar 116 engaging on the reverse tapered portion 112 of the external sleeve 105.

The expandable collar 116 conveniently consists of a plurality of arcuate wedges, the inner surface of the arcuate wedges having a number of ridges 114 so shaped as to mate with the grooves 109 around the external surface of the cylindrical end 108.

According to a possible embodiment the external surface of each arcuate wedge incorporates a tapered portion engaging on the reverse tapered portion 112 of the external sleeve 105, and a groove locating a surrounding elastic membrane 117. The external surface of each arcuate wedge may incorporate a ridge 118 to abut against the external sleeve 105 assisting in the alignment of the arcuate wedge.

The coupling is thus an arrangement such as is known for example from UK patent GB 2367873 and European Patent EP 0837288.

It will be understood that the respective projections of the illustrated embodiments and their respective recesses and coupling mechanisms are merely examples of possible projections/recesses coupling arrangements within the scope of the invention. Each is not dependent upon the other, and may be used as a first projection independently with any other appropriate second projection, for example of identical or similar design to the first projection or of other different design.

In particular the example coupler device illustrated by FIGS. 1 to 4 shows only one example combination of first and second projecting portions. FIG. 6A to F shows six alternative forms of coupler device embodying differently configured projecting portions. Two adjacent members such as two tunnel segments (omitted for clarity) will be joined in like manner to the illustration of FIG. 1.

In FIG. 6A both projecting portions have a tapered end portion to effect a simple interference fit in a blind hole in a member such as a tunnel segment in like manner to that shown by the right hand projection 16 of FIG. 1.

In FIG. 6B one projecting portion has a grooved pin and a complementary socket is provided in the member such as the tunnel segment in like manner to that shown by the right hand projection 16 of FIG. 1 to effect an interlock connection.

In FIG. 6C both projecting portions have a grooved pin with a complementary socket provided.

In FIG. 6D a back to back arrangement is shown which might be considered to effect a ring joint as well. By way of example only all projecting portions have a grooved pin with a complementary socket provided.

In FIG. 6E one side is shown pre-bolted into place.

In FIG. 6F both projecting portions have a profiled surface, but rather than being employed as an interlock with a complementary socket this is envisaged to provide a modified interference fit.

These and other structures within the scope of the invention may be used in various combinations to provide a coupler device.

FIG. 7 shows a possible internal structure and method of fabrication of a coupler device embodying the general principles of FIG. 1. The coupler device in the example embodiment is an acetal overmoulding on a steel reinforcing rod 201. The overmoulding is applied in two stages. First a cross moulding 203 is applied, and then end mouldings 207a, 207b are added. A grooved surface 209a 209b is moulded in a distal end of each projecting portion. The overmoulding entirely encapsulates the reinforcing rod. The material of the overmoulding gives good environmental resistance in-situ, and the reinforcing rod provides additional stiffness.

1. A coupler device assembly comprising at least two members and at least one coupler device for joining together two adjacent members, wherein the coupler device has an elongate body carrying spaced apart first and second projecting portions, and each member is provided with a recessed portion in a face thereof; wherein each of the first and second projecting portions is cooperably configured with a complementarily recessed portion in a face of a respective member such that the projecting portion is adapted to be received within the complementarily recessed portion in the face of a respective member; wherein:
each projecting portion comprises a tapered body portion and an end portion;
each recessed portion comprises a complementarily shaped recess; and
at least the end portion of the projecting portion is co-operably configured with at least an engagement portion of the complementarily shaped recess such as to tend to resist removal of the projecting portion from the recess when the projecting portion is located therein.

2. An assembly in accordance with claim 1 wherein each member is a tunnel segment and each coupler device is adapted to effect a radial/longitudinal joint between two adjacent tunnel segments.

3. An assembly in accordance with claim 2 wherein a first tunnel liner segment is provided with a first recess shaped to receive a first projecting portion of a coupler device, and a second tunnel segment is provided with a second recess shaped to receive a second projecting portion of a coupler device, the respective first and second recesses provided in respective end faces of the tunnel segments towards adjacent edges thereof.

4. An assembly in accordance with claim 3 comprising a coupler device configured when so received in the circumferential end faces of the adjacent tunnel segments to hold the radial/longitudinal joint between the adjacent segments together.

5. An assembly in accordance with claim 1 wherein a projecting portion comprises a monolithic construction adapted to be received directly into a recessed portion formed directly in a face of a member.

6. An assembly in accordance with claim 1 wherein a projecting portion is provided in association with a receiving formation structured to be retained within a member and thereby when so retained form a complementary recessed portion therein complementarily structured to receive the projecting portion and to effect a mating connection with the projecting portion.

7. An assembly in accordance with claim 1 wherein a projecting portion is configured relative to a complementary recessed portion such that with the coupler device and its respective members are assembled together the projecting portion tends to be retained in-situ in that the projecting portion and recess are co-operably structured to tend to resist removal of the projecting portion from the recess.

8. An assembly in accordance with claim 7 wherein a projecting portion is adapted to engage within a complementary recessed portion in an interference fit.

9. An assembly in accordance with claim 7 wherein one, other or both of the projecting portion and the recess has a profiled engaging surface and/or one, other or both of the projection and the recess is fabricated from, or has surface portion fabricated from, flexibly resilient material.

10. An assembly in accordance with claim 9 wherein a projecting portion and complementary recess are complementarily configured to provide for a locking retention mechanism as the projecting portion is inserted into the recess, which mechanism acts mechanically to resist removal of the inserted projecting portion.

11. An assembly in accordance with claim 1 wherein each coupler device comprises a monolithic construction, being a one piece moulding or a monolithic overmoulding on a suitable structural core.

12. An assembly in accordance with claim 1 wherein each coupler device is fabricated from and/or has an external surface and/or protective covering fabricated from a material resistant to environmental degradation.

13. An assembly in accordance with claim 1 wherein each coupler device is fabricated from and/or has an external surface and/or protective covering fabricated from a non-ferrous material.

14. A coupler device for joining together two adjacent members comprising an elongate body carrying spaced apart first and second projecting portions, wherein each of the first and second projecting portions is configured to be received within a complementarily recessed portion in a face of a respective member and thereby in use to join together the two respective members; wherein:
each projecting portion comprises a tapered body portion and an end portion;
each recessed portion comprises a complementarily shaped recess; and
at least the end portion of the projecting portion is co-operably configured with at least an engagement portion of the complementarily shaped recess such as to tend to resist removal of the projecting portion from the recess when the projecting portion is located therein.

15. A coupler device in accordance with claim 14 adapted for joining together two adjacent tunnel segments to effect a radial/longitudinal joint between two adjacent tunnel segments.

16. A coupler device in accordance with claim 14 wherein a projecting portion comprises a monolithic construction adapted to be received directly into a recessed portion formed directly in a face of a member.

17. A coupler device in accordance with claim 14 wherein a projecting portion is provided in association with a receiving formation structured to be retained within a member and thereby when so retained form a complementary recessed portion therein complementarily structured to receive the projecting portion and to effect a mating connection with the projecting portion.

18. A coupler device in accordance with claim 14 wherein a projecting portion is configured relative to a complementary recessed portion such that with the coupler device and its respective members assembled together the projecting portion tends to be retained in-situ in that the projecting portion and recess are co-operably structured to tend to resist removal of the projecting portion from the recess.

19. A coupler device in accordance with claim 14 wherein each coupler device comprises a monolithic construction, being a one piece moulding or a monolithic overmoulding on a suitable structural core.

20. A coupler device in accordance with claim 14 being fabricated from and/or having an external surface and/or protective covering fabricated from a material resistant to environmental degradation.

21. A coupler device in accordance with claim 14 being fabricated from and/or having an external surface and/or protective covering fabricated from a non-ferrous material.

22. An assembly comprising at least two members and at least one coupler device in accordance with claim 14 for joining together two adjacent members.

23. A method for joining adjacently together two members comprising the steps of:
providing a coupler device having an elongate body and spaced apart first and second projecting portions, wherein each projecting portion comprises a tapered body portion and an end portion;
providing each of two members to be joined with a recessed portion in a face thereof, comprising a complementarily shaped recess;
wherein each of the first and second projecting portions is configured to be receivingly engaged within a respective recessed portion in the face of the respective member in that at least the end portion of the projecting portion is co-operably configured with at least an engagement portion of the complementarily shaped recess such as to tend to resist removal of the projecting portion from the recess when the projecting portion is located therein; and
causing each projecting portion to be received within and thereby to become engaged within, its respective recessed portion and thereby joining together the two respective members.

24. The method of claim 23 further comprising:
bringing together a first and a second member adjacently such that an edge of a first member and an edge of a second member are held in face to face abutment;
providing a recessed portion in a face of each member in the vicinity of the respective edges; and
causing each projecting portion of a coupler device as above described to be received within, and in the preferred case to become engaged within, a respective recessed portion and thereby joining together the two respective members.

25. The method of claim 24 wherein adjacent members in face to face abutment are urged together to create a compressive force between them prior to joining.

26. The method of claim 25 wherein a gasket seal is provided between edges of adjacent members in face to face abutment, and the members are urged together to create a compressive force to close the gasket prior to joining.

27. The method of claim 23 wherein the first and second members are tunnel segments and the method is applied as a method for effecting a radial/longitudinal joint between two adjacent tunnel segments by insertion of a coupler device into recesses into the circumferential end faces of the adjacent tunnel segments.

28. The method of claim 23 wherein the first and second members are tunnel segments and the method comprises the steps of:
bringing together a first and a second tunnel segment so that the longitudinal edges are in face to face abutment;
providing a recessed portion in a face of each tunnel segment in the vicinity of the respective longitudinal edges;
optionally applying a force to urge the first and second segments together; and
causing each projecting portion of a coupler device as above described to be received within, and in the preferred case to become engaged within, a respective recessed portion and thereby joining together the two respective tunnel segments.
